(19) United States
(12) Patent Application Publication
(10) Pub. No.: US 2020/0140735 A1
(43) Pub. Date: May 7, 2020

(54) FOOD-GRADE COLD STORAGE AGENT

(71) Applicant: Tianjin Ying De Cold Chain Technology Company Ltd, Tianjin (CN)

(72) Inventor: Ze Qu, Tianjin (CN)

(21) Appl. No.: 16/179,409

(22) Filed: Nov. 2, 2018

(51) Int. Cl. C09K 5/06

(52) U.S. Cl. CPC C09K 5/066; C13B 50/002

(57) ABSTRACT

Provided herein are a food-grade cold storage agent consisting of sodium chloride, sodium salt of carboxy methyl cellulose, high fructose corn syrup and water, a method of fabrication therefor, and a kit comprising the food-grade cold storage agent. The mass percentages of the above components of the food-grade cold storage agent are 5-15%, 5-10%, 2.5-7.5% and 67.5-87.5%, respectively. The cold storage agent of the invention has the advantages of innocuity, harmlessness and no pollution, avoiding the secondary damage of cold storage agent to food or medicines in the process of storage and transportation. The cold storage agent of the invention can be widely applied to cold-chain logistics, freshness retaining by low temperature, intelligent cold station, clinical medical and other fields due to the preparation of food-grade raw materials.

### FIELD OF THE INVENTION

The invention relates to the technical field of cold storage, in particular to a non-toxic harmless and pollution-free food-grade cold storage agent.

### BACKGROUND OF THE INVENTION

Cold storage technology uses physical, chemical, mechanical and other effective means to store cooling capacity in cold storage agent and the stored cooling capacity is released when needed. The material that can not only store cold energy efficiently but also meet various physical and chemical requirements by the technology is called cold storage agent.

Cold storage agent that can not only absorb and store a large amount of cold energy at low temperature but also release a large amount of cold energy when the temperature is high is usually a viscous colloidal mixture composed of organic and/or inorganic compounds, which is able to maintain a low temperature environment within itself and a small range around for a long time.

The main problems is the breaking of the cold chain link in the field of cold chain transportation such as food and medicine vaccines, which is that food and medicines are precooled at the place of origin and loaded into transport vehicles to reach the wholesale market of the place of sale and finally enter the retail chain for storage and it is easy to break the chain of the cold chain in these links. The cold storage agent can effectively solve these problems and realize the continuity of storage temperature, thereby maximizing control of product quality and increasing added value.

The type of cold storage agent which are widely used in that exist cold storage technology are continuously updated. Some of them add poly n-vinyl acetamide and sodium borate to sodium chloride aqueous solution to make cold storage agent. Another kind of cold storage agent is polyvinyl alcohol that expands fully in water and borax cross-link to form a body structure and then absorbs a large amount of water and expands into translucent flowable gel. In addition, a large amount of ammonium nitrate, ammonium chloride, sodium chloride, calcium chloride, urea, sodium carbonate, sodium sulfate, sodium nitrate and other raw materials are added with water as a cold storage agent. The common problem of cold storage agents in the prior art is that a large amount of chemical raw materials are introduced to improve various indexes of cold storage and can't be absolutely non-toxic. Once leakage occurs during use cold storage agent, food and medicines transported or stored will be polluted, thus causing serious consequences of poisoning by users or eaters. In order to ensure that the cold storage agent does not leak, it is necessary to use a high-strength and thick clad material in the cold storage agent, which indirectly increased the use cost and the matching cost of the cold storage agent.

### SUMMARY OF THE INVENTION

In one aspect of the present invention, it is provided a food-grade cold storage agent consists of sodium chloride of 5-15%, sodium salt of caboxy methyl cellulose of 5-10%, high fructose corn syrup of 2.5-7.5% and water of 67.5-87.5%.

In some embodiments of the invention, the food-grade cold storage agent further comprises an edible essence, wherein the edible essence has a content up to 0.03 grams to per kilogram of food-grade cold storage agent.

In some embodiments of the invention, the food-grade cold storage agent further comprises a food coloring agent, wherein the food coloring agent has a content up to 0.05 grams to per kilogram of food-grade cold storage agent.

In some embodiments of the invention, the food-grade cold storage agent further comprises a food coloring agent, wherein the food coloring agent has a content up to 0.05 grams to per kilogram of food-grade cold storage agent.

In another aspect of the present invention, it is provided a method of fabricating a food-grade cold storage agent consisting of sodium chloride of 5-15%, sodium salt of caboxy methyl cellulose of 5-10%, high fructose corn syrup of 2.5-7.5%, an optional edible essence, an optional food coloring agent, and water of 67.5-87.5%, which method comprising:

a) heating the water until boiling, after cooling, filtering and descaling the water;

b) heating the water until boiling again, adding sodium chloride and fructose syrup, adding sodium carboxymethyl cellulose while stirring to form a gruel mixture;

c) naturally cooling the mixture to room temperature, adding the optional edible pigment and/or edible food pigment, if any, and stirring to uniformly disperse, to obtain the food-grade cold storage agent,

wherein the optional edible essence has a content up to 0.03 grams to per kilogram of food-grade cold storage agent, and

wherein the optional food coloring agent has a content up to 0.05 grams to per kilogram of food-grade cold storage agent.

In some embodiments of the invention method, the food-grade cold storage agent comprises the edible essence.

In some embodiments of the invention method, the food-grade cold storage agent comprises the food coloring agent.

In some embodiments of the invention method, the food-grade cold storage agent comprises the edible essence and food coloring agent.

In another aspect of the present invention, it is provided a kit for cold delivery or transportation, the kit comprising an article in a cold state and a food-grade cold storage agent consists of sodium chloride of 5-15%, sodium salt of caboxy methyl cellulose of 5-10%, high fructose corn syrup of 2.5-7.5% and water of 67.5-87.5%.

In some embodiments of the invention kit, the article is a pharmaceutical article, a biologics article, a cosmetic article, a food article, or a nutritional supplement.

In some embodiments of the invention kit, the food-grade cold storage agent further comprises an edible essence, and the edible essence has a content up to 0.03 grams to per kilogram of food-grade cold storage agent.

In some embodiments of the invention kit, the food-grade cold storage agent further comprises a food coloring agent, and the food coloring agent has a content up to 0.05 grams to per kilogram of food-grade cold storage agent.

In some embodiments of the invention kit, the food-grade cold storage agent further comprises a food coloring agent, and the food coloring agent has a content up to 0.05 grams to per kilogram of food-grade cold storage agent.

### DETAILED DESCRIPTION OF THE INVENTION

The technical problem to be solved by the invention is to provide a food-grade cold storage agent which is nontoxic, harmless and pollution-free.

The technical scheme adopted by the invention to solve the technical problems existing in the known technology is as follows:

A food-grade cold storage agent of the invention has the following components (% by weight):

sodium chloride: 5-15%;

sodium salt of caboxy methyl cellulose: 5-10%;

high fructose corn syrup: 2.5-7.5%;

water: 67.5-87.5%.

The invention can also adopt the following embodiments:

For example, in some embodiments, the food-grade cold storage agent further comprises edible essence with an upper limit of 0.03 grams per kilogram of food-grade cold storage agent, for example, 0.001 gram to 0.03 grams edible essence per kilogram of the food-grade cold storage agent.

In some embodiments, the food-grade cold storage agent further comprises edible pigment with an upper limit of 0.05 grams per kilogram of food-grade cold storage agent, for example, 0.001 gram to 0.05 grams edible pigment per kilogram of the food-grade cold storage agent.

As used herein, the term “high fructose corn syrup” refers to a corn syrup having a higher content of fructose than that of glucose in that the Fructose/(Fructose+Glucose) (“here after referred to as “fructose weight ratio” or as “FWR”) is higher than 0.5, e.g., within a range of 0.5-1.0, 0.6-1.0, 0.7-1.0, 0.8-1.0, or 0.9-1.0, or specifically, 0.55, 0.6, 0.7, 0.8, 0.9, 0.95 or 1.0. The fructose ratio is an important parameter as fructose imparts structural integrity to, and helps maintain, the food-grade cold storage agent of invention, which is highly desirable in the cold storage/cold chain industry.

As used herein, the term “edible essence” refers to any edible essence commonly used in the food industry.

As used herein, the term “edible pigment” refers to any edible pigment commonly used in the food industry. The term “edible pigment” is used interchangeably with the terms “edible food pigment” or “food pigment” or “food coloring agent.”

As used herein, the term “article” refers to any article of commerce or personal use/consumption which requires cold storage, such as a pharmaceutical article, a biologics article, a cosmetic article, a food article, or a nutritional supplement. In this context, a food article can be a cooked food article or a raw food article that require cold storage, for example, raw or cooked animal meat, fish or any farming or fishery products.

As used herein, the term “cold state” refers to a temperature of about 0° C. or below, for example, a temperature of about −5° C., about −7° C., about −10° C., about −15° C., about −18° C., or about −20° C. In this context, the ability/capacity of the food-grade cold storage agent of invention capable of causing an article to reach or maintain a cold state is referred to as “cold energy.”

The invention has the advantages and beneficial effects as described below:

Since the preparation raw materials used in the food-grade cold storage agent of the invention are all food-grade raw materials and obtained finished product of food grade cold storage agent is also food grade with the advantages of no toxicity, no harm and no pollution. The food-grade cold storage agent can be widely applied to cold chain logistics, low temperature preservation, intelligent cold stations, clinical medical treatment and other fields, thus avoiding the secondary harm of the cold storage agent to food or medicines during storage and transportation. When leakage occurs, the colored cold storage agent can also directly indicate the leakage source for easy replacement. The food-grade cold storage agent of the invention has better low-temperature flow performance and is always in a non-solidified state in the process of using, so it is possible to use a lower strength clad material to reduce the use cost of the cold storage agent.

### Fabrication

Hereinafter, the present invention is described in detail with reference to examples.

A food-grade cold storage agent of the invention comprises the following components: Water, sodium chloride, sodium carboxymethyl cellulose and high fructose syrup, the mass percentages of the components are as follows:

sodium chloride, of 5-15%, which adjusts the phase change temperature of the cold storage agent through sodium chloride;

sodium carboxymethyl cellulose, of 5˜10%, which thickens and stabilizes the cold storage agent so that the cold storage agent is in a stable viscous state;

high fructose syrup, of 2.5˜7.5%, which changes the taste of the cold storage agent while the phase change temperature is adjusted; and

the balanced being water.

In some embodiments, the food-grade cold storage agent further comprises edible essence with an upper limit of 0.03 grams per kilogram of food-grade cold storage agent, for example, 0.001 gram to 0.03 grams edible essence per kilogram of the food-grade cold storage agent.

In some embodiments, the food-grade cold storage agent further comprises edible pigment with an upper limit of 0.05 grams per kilogram of food-grade cold storage agent, for example, 0.001 gram to 0.05 grams edible pigment per kilogram of the food-grade cold storage agent.

### Example 1

Taking 1 kilogram of food grade cold storage agent as an example, the following components (% by weight) are:

sodium chloride: 50 g;

sodium carboxymethyl cellulose: 50 g;

high fructose syrup: 75 g;

edible pigment: 0.05 g;

no edible essence added;

the balance being water.

The food-grade cold storage agent of the invention can be fabricated by a process comprising the following steps:

a) heating the water until boiling, after cooling, filtering and descaling the water;

b) heating the water until boiling again, adding sodium chloride and fructose syrup, adding sodium carboxymethyl cellulose while stirring to form a gruel mixture;

c) naturally cooling the mixture to room temperature, adding edible pigment, and stirring to uniformly disperse, to obtain the food-grade cold storage agent.

The thus obtained per kilogram of food-grade cold storage agent can release cold energy in an incubator for at least 2 hours to keep the temperature inside the box at about 0° C.

### Example 2

Taking 1 kilogram of food grade cold storage agent as an example, the following components (% by weight) are:

sodium chloride: 150 g;

sodium carboxymethyl cellulose: 100 g;

high fructose syrup: 25 g;

edible pigment: 0.04 g;

edible essence: 0.03 g;

the balance being water.

The food-grade cold storage agent of the invention can be fabricated by a process comprising the following steps:

a) heating the water until boiling, after cooling, filtering and descaling the water;

b) heating the water until boiling again, adding sodium chloride and fructose syrup, adding sodium carboxymethyl cellulose while stirring to form a gruel mixture;

c) naturally cooling the mixture to room temperature, adding edible pigment and edible essence, and stirring uniformly to obtain the food-grade cold storage agent.

The thus obtained per kilogram of food-grade cold storage agent can release cold energy in an incubator for at least 2 hours to keep the temperature inside the box at about −15° C.

### Example 3

Taking 1 kilogram of food grade cold storage agent as an example, the following components (% by weight) are:

sodium chloride: 100 g;

sodium carboxymethyl cellulose: 60 g;

high fructose syrup: 40 g;

no edible pigment added;

edible essence: 0.02 g;

the balance being water.

The food-grade cold storage agent of the invention can be fabricated by a process comprising the following steps:

a) heating the water until boiling, after cooling, filtering and descaling the water;

b) heating the water until boiling again, adding sodium chloride and fructose syrup, adding sodium carboxymethyl cellulose while stirring to form a gruel mixture;

c) naturally cooling the mixture to room temperature, adding edible essence, and stirring to uniformly disperse, to obtain the food-grade cold storage agent.

The thus obtained per kilogram of food-grade cold storage agent can release cold energy in an incubator for at least 2 hours to keep the temperature inside the box at −7° C.

### Kit

In another aspect of the present invention, it is provided a kit for cold delivery or transportation, the kit comprising an article in a cold state and a food-grade cold storage agent consists of sodium chloride of 5-15%, sodium salt of caboxy methyl cellulose of 5-10%, high fructose corn syrup of 2.5-7.5% and water of 67.5-87.5%.

In some embodiments of the invention kit, the article is a pharmaceutical article, a biologics article, a cosmetic article, a food article, or a nutritional supplement.

In some embodiments of the invention kit, the food-grade cold storage agent further comprises an edible essence, and the edible essence has a content up to 0.03 grams to per kilogram of food-grade cold storage agent.

In some embodiments of the invention kit, the food-grade cold storage agent further comprises a food coloring agent, and the food coloring agent has a content up to 0.05 grams to per kilogram of food-grade cold storage agent.

In some embodiments of the invention kit, the food-grade cold storage agent further comprises a food coloring agent, and the food coloring agent has a content up to 0.05 grams to per kilogram of food-grade cold storage agent.

The above description is only a preferred embodiment of the present invention and is not intended to limit the present invention in any way. Although the present invention has been disclosed in the preferred embodiment as above, it is not intended to limit the present invention. Any person skilled in the art that will not depart from the scope of the technical scheme of the present invention certainly can make some changes or modifications to equivalent embodiments with equivalent changes by using the disclosed technical content. However, what does not depart from the technical scheme of the present invention are all within the scope of the technical scheme of the invention for any simple modifications and equivalent changes made to the above embodiments in accordance with the technical essence of the present invention.

1. A food-grade cold storage agent comprising sodium chloride of 5-15%, sodium salt of carboxy methyl cellulose of 5-10%, high fructose corn syrup of 2.5-7.5% and water of 67.5-87.5%, wherein the high fructose corn syrup has a higher content of fructose than that of glucose and has a fructose weight ratio (“FWR”) that is about 0.55, 0.6, 0.7, or 0.8.

2. The food-grade cold storage agent according to claim 1, further comprising an edible essence, wherein the edible essence has a content up to 0.03 grams to per kilogram of food-grade cold storage agent.

3. The food-grade cold storage agent according to claim 1, further comprising a food coloring agent, wherein the food coloring agent has a content up to 0.05 grams to per kilogram of food-grade cold storage agent.

4. The food-grade cold storage agent according to claim 2, further comprising a food coloring agent, wherein the food coloring agent has a content up to 0.05 grams to per kilogram of food-grade cold storage agent.

5. A method of fabricating a food-grade cold storage agent comprising sodium chloride of 5-15%, sodium salt of carboxy methyl cellulose of 5-10%, high fructose corn syrup of 2.5-7.5%, an optional edible essence, an optional edible food coloring agent, and water of 67.5-87.5%, the method comprising:
a) heating the water until boiling and, after cooling, filtering and descaling the water;
b) heating the water until boiling again, adding sodium chloride and fructose syrup, adding the sodium salt of carboxy methyl cellulose while stirring to form a gruel mixture;
c) naturally cooling the mixture to room temperature, adding the optional edible essence and/or edible food coloring agent, if any, and stirring to uniformly disperse, to obtain the food-grade cold storage agent,
wherein the optional edible essence has a content up to 0.03 grams to per kilogram of food-grade cold storage agent,
wherein the optional edible food coloring agent has a content up to 0.05 grams to per kilogram of food-grade cold storage agent, and
wherein the high fructose corn syrup has a higher content of fructose than that of glucose and has a fructose weight ratio (“FWR”) that is about 0.55, 0.6, 0.7, or 0.8.

6. The method according to claim 5, wherein the food-grade cold storage agent comprises the edible essence.

7. The method according to claim 5, wherein the food-grade cold storage agent comprises the edible food coloring agent.

8. The method according to claim 5, wherein the food-grade cold storage agent comprises the edible essence and the edible food coloring agent.

9. A kit for cold delivery or transportation, comprising an article in a cold state and a food-grade cold storage agent comprising sodium chloride of 5-15%, sodium salt of carboxy methyl cellulose of 5-10%, high fructose corn syrup of 2.5-7.5% and water of 67.5-87.5%,
wherein the high fructose corn syrup has a higher content of fructose than that of glucose and has a fructose weight ratio (“FWR”) that is about 0.55, 0.6, 0.7, or 0.8.

10. The kit according to claim 9, wherein the article is a pharmaceutical article, a biologics article, a cosmetic article, a food article, or a nutritional supplement.

11. The kit according to claim 9, wherein the food-grade cold storage agent further comprises an edible essence, and wherein the edible essence has a content up to 0.03 grams to per kilogram of food-grade cold storage agent.

12. The kit according to claim 9, wherein the food-grade cold storage agent further comprises a food coloring agent, and wherein the food coloring agent has a content up to 0.05 grams to per kilogram of food-grade cold storage agent.

13. The kit according to claim 11, wherein the food-grade cold storage agent further comprises a food coloring agent, and wherein the food coloring agent has a content up to 0.05 grams to per kilogram of food-grade cold storage agent.
